(19) United States
(12) Patent Application Publication
(10) Pub. No.: US 2001/0032156 A1
(43) Pub. Date: Oct. 18, 2001

(54) System and method for evaluating work product

(76) Inventors: Dan Candura, Braintree, MA (US); Dawn Gunderson, Mahtomedi, MN (US); Deana Smythe, Minneapolis, MN (US); Edward R. Stober JR., Farmington, MN (US); Jake Chaya, Burnsville, MN (US); Gregory J. Wright, St. Louis Park, MN (US); Gayle J. Appelbaum, Minneapolis, MN (US); David A. Carles, Blaine, MN (US); Jana Etheridge, Minneapolis, MN (US); Daniel D. Hastings, Hudson, WI (US); Debra Osweiler, Minneapolis, MN (US); Linne M. Jensen, Northfield, MN (US); Roger X. Erny, St. Louis Park, MN (US); Jeffrey S. Ramsey, Shorewood, MN (US)

Correspondence Address: Snell & Wilmer, L.L.P., One Arizona Center, 400 East Van Buren, Phoenix, AZ, 85004-2202, US

(21) Appl. No.: 09/731,163

(22) Filed: Dec. 6, 2000

Related U.S. Application Data
(60) Provisional application No. 60/169,375, filed on Dec. 7, 1999.

(51) Int. Cl. G06F 17/60

(52) U.S. Cl. 705/36; 705/35; 705/10; 705/11

(57) ABSTRACT

The invention is a system and method for evaluating written work-product which includes several categories in which work-product is rated using a unique set of Levels and categories. An exemplary embodiment of the rating scheme includes a rating scale of integers from 1 to 5, inclusive, in which rating below 3 is considered unacceptable. After a particular piece of work-product is reviewed, another piece of work-product produced by the same person may also be reviewed. Typically, each review is performed by two reviewers. In the event that two reviewers disagree as to the rating of a particular work-product item, a third reviewer, or arbitrator, is used to rate the work-product again to determine a rating for the product. Each creator of work-product may have two or more items of their work-product reviewed to determine the overall quality of the creator's work.

### CROSS-REFERENCE TO RELATED APPLICATION

This application claims priority from Provisional Application Ser. No. 60/169,375, filed Dec. 7, 1999, the contents of which are hereby incorporated by reference.

### BACKGROUND OF THE INVENTION

1. Technical Field of the Invention

The present invention relates generally to work product evaluation, and more particularly, to a method and system of reviewing and evaluating the written work product of financial advisors.

2. Description of Related Art

Financial advisors are often hired to provide a variety of financial advice to a variety of entities, such as individuals, trusts, and corporations. The advice given may include advice concerning how to invest money, how to plan for retirement or college education of children, how much money to save, and how to save money. Some financial advisors may provide adequate advice to their customers, but other financial advisors may not be as successful. However, in certain circumstances, it may be difficult to determine whether a financial advisor is providing insufficient work-product or superior work-product. This problem may be exacerbated in an organization in that a supervisor may have the difficult task of evaluating several financial advisors. In addition, there may be several supervisors, each with different expectations regarding the appropriate advice.

In the past, there were a few methods for evaluating a financial advisor. However, these methods suffered from a variety of drawbacks. Among these methods are the evaluation of feedback from clients, such as the number of complaints or “Thank you” letters submitted regarding a particular advisor. In addition, a supervisor of a group of financial advisors may also compare the work of his subordinates to the supervisor's own work product. However, different supervisors may have their own standards of what qualifies as acceptable work product.

It would be beneficial to have a method for evaluating the performance of an advisor. It would also be beneficial for financial advisors in general, and a group of financial advisors in particular, to have a set standard by which their work is measured. In that regard, not only is each individual advisor evaluated, but the group as a whole may also be evaluated to improve the service provided by the group of financial advisors. In addition, such a set standard would also be useful for individual advisors, as they would be able to determine if their work product meets the needs of their clients.

### SUMMARY OF THE INVENTION

The present invention discloses a multi-step system and method for gathering, evaluating, and scoring written advice provided by financial advisors to their clients. The process allows a company to provide meaningful data regarding the advice across a market group and provide distinctive differences between different areas of financial planning as well as distinct differences between different groups of financial advisors. The system also allows a company to monitor whether the quality Level of advice provided by the financial advisors over a predetermined period of time is static, increasing, or decreasing.

The present invention involves the evaluation of written work-product prepared by a financial advisor. In one embodiment of the invention, the work-product is read, then rated by comparing the work-product to a standard that is established beforehand. Thereafter, the case is assigned a numerical value that is based on the above comparison. There may be more than one piece of work-product of each financial advisor being reviewed. In addition, the evaluation process may be carried out in a manner such that each piece of work product is evaluated by different people. In addition, more than one piece of work product may be selected for review.

The rating method being used may be a numerical rating using integers from 1 to 5, in which a higher number indicates higher compliance with the standard. An exemplary rating system may equate a rating of 1 with questionable work product; a rating of 2 to limited work product; a rating of 3 to reasonably informative work product; a rating of 4 to reasonably detailed work product; and a rating of 5 to outstanding work product.

The work product may be evaluated in a number of different areas, such as Financial Planning; Financial Position; Protection Planning; Disability; Life Insurance; Long-Term Care; Investment Planning; Tax Planning; Retirement Planning; Estate Planning; Communication; and Overall rating.

An alternative listing of areas in which work product may be rated includes the following: Cash reserves; Budget/Expenses/Cash Flow/Debt Management; Overall Financial Position rating; Disability Insurance; Affordability of Disability Insurance Recommendation; Feasibility of Goal Achievement regarding Disability Insurance recommendation; Overall rating of Disability Insurance section; Affordability of Life Insurance Recommendation; Feasibility of Goal Achievement regarding Life Insurance recommendation; Overall rating of Life Insurance section; Affordability of Long-Term Care Recommendation; Feasibility of Goal Achievement regarding Long-Term Care Recommendation; Overall rating of Long-term Care section; Affordability of Investment Planning Recommendation; Documentation of risk tolerance of the client; Exploration of tax ramifications of Investment Planning recommendation; Feasibility of Goal Achievement regarding investment planning recommendation; Overall rating of Investment Planning section; Advice with respect to Tax-qualified investments; Advice with respect to Tax-deferred investments; Advice with respect to Tax-exempt investment; Advice regarding tax effect of liquidating certain investments; Advice regarding the hiring of a tax advisor; Overall rating of Tax Planning section; Affordability of Retirement Planning Recommendation; Documentation of risk tolerance regarding Retirement Planning; Exploration of tax ramifications of Retirement Planning Recommendation; Feasibility of Goal Achievement regarding Retirement Planning Recommendation; Overall rating of Retirement Planning section; Advice regarding wills, trusts, or other estate planning techniques; Advice regarding beneficiary designations and/or ownership issues; Advice regarding Estate Tax situation; Advice regarding the hiring of an estate planning attorney; Overall rating of Estate Planning section; Linkage of various financial planning areas to another; Organization and presentation; Statement of sources of information and/or assumptions; and Overall rating of the work-product.

In the event that two different raters (or assessors) rate a piece of work product differently, an embodiment of the present invention provides for an additional assessor (called an arbitrator) to further evaluate the work product and finalizing a rating based on the evaluation of the arbitrator.

In one

### BRIEF DESCRIPTION OF THE DRAWINGS

The present invention is illustrated by way of example, and not limitation, in the accompanying figures, in which like reference numbers indicate similar elements, and in which:

FIG. 1 is a flowchart illustrating the steps performed in evaluating a financial advisor in an exemplary embodiment of the present invention; and,

FIG. 2 is a flowchart illustrating the steps performed by an assessor in evaluating a financial advisor in an exemplary embodiment of the present invention.

### DETAILED DESCRIPTION OF EXEMPLARY EMBODIMENTS

A typical scenario involves a client that hires a financial advisor to obtain financial advice. For example, a person may hire a financial advisor to determine how to properly invest for his retirement, or to ask for advice as to how much to spend on a house. After conducting an interview with the client or otherwise obtaining information that the advisor believes will be relevant, the financial advisor may provide written work-product, often called a “case”, detailing the recommendations for the client. This advice may include general financial advice or may include more specific advice relating to the client's stated goals. Ideally, the information presented is specifically tailored for the client and lists, in detail, recommended actions and presents the reasons for the recommendations.

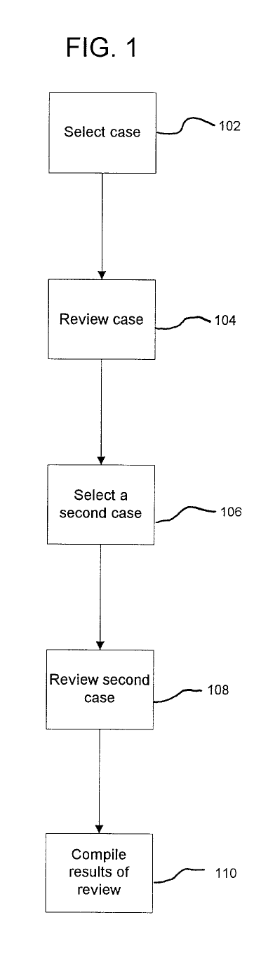

The present invention provides a method through which “cases” are rated. It also provides a method with which to rate the work of a group of advisors. FIG. 1 presents a flowchart illustrating a broad overview of exemplary steps of an exemplary rating process in accordance with the present invention. A first case of a particular financial advisor is selected (step 102). The selection may be random, chronological (e.g., the most recently prepared case of the advisor may be selected), or it may be selected in any another manner. The assessor reviews the case (step 104) and evaluates the case. Optionally, a second case of the financial advisor is chosen (step 106) and the assessor reviews and evaluates the second case also (step 108). The second selection may occur simultaneously with the selection of the first case, or the second selection may be made after the assessor has evaluated the first case. After all reviews are completed, the assessors compile their evaluations of the cases (step 110), described in more detail below.

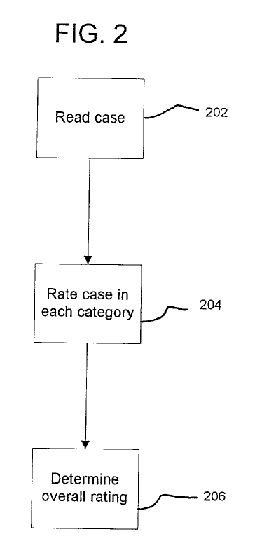

FIG. 2 details exemplary steps performed by an assessor in reviewing, rating, and evaluating a case. The assessor reads the case (step 202) and rates it in multiple categories (step 204), then the assessor assigns an overall rating to the case based on the quality of the advice in each category (step 206). One such rating may be a numeric rating, on a scale that ranges from, for example, a low of one to a high of five, using integers. Alternatively, any graphical, symbolic, character or other indicator may be used. In an exemplary embodiment, the scale of one to five is configured generally as follows:

1 ) the advice is considered questionable;

2) the advice is considered limited;

3) the advice sufficiently answers the question “what to do” and may be considered basic advice;

4) the advice, in addition to providing all the characteristics of Level three advice, also details the reasons for a client to take a particular action and how it should be done; and

5) the advice is considered outstanding; it has all the characteristics of Level four advice, and also provides an analysis of alternative courses of actions. Advice receiving a rating of 5 is considered superior to Level 4 advice because it provides unique advice or creative solutions tailored to the client's situations.

More specifically, with respect to Level 1, namely, advice is questionable, an assessor may wish to have a discussion with the advisor to determine the reasons for the particular advice. For example, the case may advise a client to place $500 per month into an SEP-IRA in order to save for the education of his child. This advice is questionable for the failure to provide any reasoning or details as to the advice. The assessor may wish to speak with the advisor to determine the reasons for the recommendations.

Level 2 advice may not adequately answer the question “what to do?” or the recommendations may be inconsistent with the analysis. An example of an inconsistent recommendation occurs when the analysis provides that a client requires $1000 per month in disability insurance to adequately protect herself and her family. However, the recommendations may be that the client procure disability insurance of $500 per month, without giving any reasons as to the discrepancy. An example of the failure to answer the “what to do” question would be a statement such as “invest for growth and income,” or “utilize your discretionary income towards your goals,” that fails to give clients the specifics needed to carry out the advice.

Level 3 advice answers the question “what to do?”, namely, clear, thorough, objective or specific advice begins to appear in the documentation. Furthermore, the advice is reasonable and actionable in that the client is able to follow the advice to reach her goals. An example of advice that satisfies the Level 3 standard of this embodiment would be, “invest excess discretionary income in mutual funds to help fund your education goal,” or “prepare a 30-day diary of your expenses to help manage your cash flow.”

Level 4 advice provides further details as to the reasoning for the recommendations and the manner in which the recommendations may be implemented. The advice may answer the question of who should be carrying out the recommendations and when the recommendations should be implemented. Furthermore, clear, thorough, specific advice is more evident in the case. An example of advice that may be considered Level 4 advice is the following: “John, consider investing $500 of your monthly discretionary income into the AXP Blue Chip Advantage Fund for Mary's education goal.”

In order to improve Level 3 advice such that it becomes Level 4 advice, the advisor may wish to add more details. For example, assume that the given advice was “prepare a 30-day diary of all expenses. Include miscellaneous expenses and average annual bills to create a monthly expense.” The reason that the above advice is not considered Level 4 is that the advice provides no details as to what the clients should do once they prepare the 30-day expense diary. Furthermore, the clients are given no reasons as to why they should prepare an expense diary.

An exemplary version of the advice given above that meets the criteria for Level 4 advice is as follows:

Prepare a 30-day diary of all expenses. Include miscellaneous expenses and average annual bills to create a monthly expense. Once you have confirmed that your discretionary income is the $1,000/month and you feel comfortable allocating that amount towards your goals, consider the following allocation:

Invest $200/ month into an American Express Cash Management fund to help build your cash reserves (refer to the cash reserve section for additional details).

Invest $500/month into a Retirement Advisor Variable Annuity to help supplement your retirement savings (refer to the retirement and asset management sections for specific details regarding this contribution).

Invest $300/month into the American Express New Dimensions fund to help start the savings program for Johnny's college education fund (refer to Johnny's education scenario for specifics).

The above advice meets the criteria for Level 4 advice because reasons were given for the preparation of a 30-day diary of expenses. In addition, the advice was provided with information as to the actions to be taken after the diary has been completed.

Another sample of Level 4 work is as follows:

Sam and Susan consider allocating your committed
discretionary income of $1,000 per month and your “found”
money towards the following goals:

| Cash Inflows | |
|---|---|
| Discretionary Income | $1,000 |
| “Found” Money from adjusting tax withholdings | $500 |
| TOTAL Inflow | $1,500 |
| Cash Outflows | |
| Allocate dollars into an American Express Cash Reserve | $200 |
| Certificate to fund your cash reserve goal | |
| (see cash reserve section for additional details) | |
| Allocate dollars into an American Express Retirement | $500 |
| Advisor Annuity (See the retirement planning section for | |
| additional details) | |
| Establish a monthly savings program to achieve Kim, Kelly, | $600 |
| and Karla's Education goals (see the education planning | |
| section for details) | |
| Purchase a Variable Universal Life policy on Sam's life | $200 |
| (See Sam's premature death section for details) | |
| TOTAL Outflow | $1,500 |

An Advisor can use additional information to improve Level 3 work such that it satisfies the criteria of Level 4 work. For example, the advisor should include personal information that demonstrates an understanding of the client's situation. This information includes the client's name, the names of any children of the client, and the company's plans and benefits. The advisor should also mention assumptions that are used in the analysis and in the proposed strategy. (e.g., although analysis shows that the client has $800 per month of discretionary income, the client asserts that he will be able to invest $1000 per month.) The advisor should also ensure that the client has adequate resources to implement the proposed strategy (e.g., the advisor should not recommend the investment of $1000 per month when the client has discretionary income of $750 per month.) Furthermore, the case should address the connection between different areas of a case, in the event that a recommendation impacts another area of the client's situation.

Level 5 advice, in addition to providing the aspects of Level 4 advice, stands out in that the advice may provide options, evaluate the pros and cons of the situations, or provide creative or unique solutions that are tailored to the client's situation. An example of advice that may be considered Level 5 advice follows:

John, based on our discussion regarding your moderately conservative risk tolerance, your timeframe, and your education goal: consider saving $500 of your monthly (small business) income into your SEP-IRA, investing in the AXP Blue Chip Advantage Fund to save for Mary's education. The advantage of using your SEP IRA versus an after-tax investment is that you may reduce your annual tax liability, the money in the SEP-IRA has tax-deferred growth, and money saved in qualified retirement plans are currently not part of financial aid calculations. The disadvantage of using your SEP-IRA is that you will not be eligible to use the funds without penalty until you are 59½ and you may not be in a lower tax bracket when you take distributions to pay for Mary's education costs. Consult with your tax advisor regarding this strategy and the impact of pre-tax savings on your current federal and state income tax withholdings.

The following is another example of Level 5 advice: Dear John and Ann:

The following are the key facts, thoughts and recommendations from our meeting of this past Thursday, to the best of my notes and recollections.

1. You have been in the Navy for 14 years, much of that time as a carrier administrator on the USS Enterprise. You are currently working at Annapolis, but will be going back to the Norfolk, Va. naval base in January-February 2001 upon your reassignment.

The purpose of our meeting is to reach a consensus regarding the magnitude of the new home purchase that you and Ann can afford in Norfolk, Va., and some general guidelines regarding mortgage financing.

2. You are currently earning about $63,000 annually. Your base (about $39,800) is scheduled to increase by 3.5% on Jan. 1, 2001, while the additional pay component (about $2,600) should increase by about $2,100. At 16 years of service, you will be eligible for a “time in trade” increase while you will be in line for a promotion to full Commander at between 17 and 18 years of service.

3. Upon reassignment to the USS Vincent, you anticipate spending the first 11 months in a general staff position, then the next 15 months in an executive office position with the USS Vincent team. Following that, you hope to attend graduate school in Charlottsville, Va. You are uncertain as to whether you will remain in the Navy for a total of 20 years or more.

4. Ann, you are currently working at the accounting firm of Cambridge Associates with an annual salary of about $57,000. You are uncertain regarding the details of your qualified retirement plans. Although professionally trained as an accountant, you are currently employed as a form of a technology project manager to transition the firm to new computers, software, and database management.

5. Upon your move to Virginia, Ann, you stated that you would be looking to either continue your foray into the “technology for accountancy business” or would be interested in returning to your accountant role in the firm.

6. Based upon our earlier conversations, Ann, you have Rheumatoid Arthritis, but the symptoms are currently in remission. Your medication costs about $1,200 annually and is covered to a significant degree by the Medcorp Group, your health insurance program.

7. You have no children and do not anticipate having any in the near future. In the long term, the matter of children is an unknown matter.

8. You own a home in Manassas, Va. which is currently renting for about $1,350 per month. The principle, interest, taxes, and insurance (PITI) is about $1,125 per month. Combined with the depreciation allowance, tax write-off amounts to about $7,450 annually. Thus, you are not “out of pocket” to a significant degree. Your tenant takes very good care of the property and the mortgage debt was recently refinanced. You manage the property yourself.

9. You purchased the property for about $119,000 and estimate its market value at between $143,000 and $155,000. It has a prime location, about a mile from the National Battlefield and the major highway.

10. Both of your cars are paid off and in a good state of repair. There is about $1,700 remaining on a student loan of Ann's from Pennsylvania and disputed tax lien with the state of Maryland.

11. You pay state income tax currently in Maryland, but will not be paying state income tax in Virginia.

12. Your cash reserves consist of about $3, 100 in the household bank accounts and about $1,800 in a money market account at Fidelity.

13. You have been investing about $125 per month into six other Fidelity accounts, currently values in the $75,000 range.

14. You are interested in purchasing a home in Norfolk, Va. upon your reassignment. A 1200-1400 square foot home can run about $260,000 due to the price of land. You have a bid on a house in Norfolk for $405,000, subject to visual inspection by both of you, which will occur this week. The Realtor that you are working with is married to a mortgage broker. She has suggested a loan involving 20% down.

15. We have discussed at great length the likely limits of you loan qualifications, utilizing both our mutual experiences as well as the general guidance provided by my Home Affordability Guide.

I suggest that you consult with your tax advisor on the following assumptions and recommendations.

Assuming a pre-tax equivalent annual income of about $130,000, and a non-conforming loan interest rate, it would appear that $405,000 is very likely the outermost limit for the price of a home you can afford. While you could probably scrape together the resources to make a 20% down payment, all of your liquidity would be drained. As noted above, you were not clear regarding thew level of resources within Ann's retirement plans that might be available to aid in the financing of the new home purchase. Further stressing the situation is the need for Ann to locate a new job; while very employable, she might want to search around for the right position at the right salary and that may not be immediately available. Also, while the Manassas property is currently leased to a very solid tenant, that situation could change and you might be facing the need to carry the property while having to engage a real estate services firm to re-lease the property and perhaps manage it.

Of course, you might consider selling that property and releasing the equity to enhance your cash resources, net of the tax due on the taxable gain.

Now it should be noted that you thought your monthly living expenses above your current rental payment ($2,250 per month) to be about $2,000. However, they likely are more even if we assume 35% of gross earnings (about $3,800) goes to taxes and another goes to investment accounts like Fidelity funds and Ann's retirement plans. It may be, however, that the additional current spending is discretionary and could be turned to meeting the larger monthly housing outlay, a large proportion of which would become deductible, by the way. Thus, you likely would be able to rebuild your liquidity cushion within a few years assuming disciplined savings and no sustained break in your earnings streams. It would seem to be very important for the two of you to sit down in the very near future to review your spending details. At that time, determine the component that is properly committed, the amount that is discretionary but necessary and the amount which is wholly discretionary and available for savings if you only make the choice.

I remain uncomfortable with the idea of your draining all of your liquidity to reach the 20% down payment level, particularly if the house you are buying is not the house that you would expect to retire to. I encourage you to explore further your financing options including 80/10/10 loans (i.e., use of a second trust balloon loan to avoid the PMI requirement), a less expensive property and/or simply going with a 90/10 loan. As to the interest rate program, your mortgage banker is better positioned to advise you, but I am leery about paying much in the way of points until you are clearer regarding your time horizon in the property. Obviously, paying points involves cash resources, which may already be stretched depending on the level of down payment.

In short, everything seems to be working for now. I am concerned that you may be stretched too far if everything stops working as well.

I believe that the above summarizes the key conclusions and recommendations from Thursday's meeting. You seemed to be in agreement with me when you left. If I can be of further assistance to you and Ann as you move forward, please do not hesitate to call.

For the above description of exemplary Levels of advice, an organization or an individual may set a minimum standard. For example, an organization may decide that cases should be Level 3 or above. If a case receives a rating of Level 1 or Level 2, the advisor that wrote the case may be advised of the shortcomings and reminded of the standards to which the advisor is being held. Another organization using the above exemplary Levels of advice may decide that the advisors in the organization should strive to produce work-product that is Level 4 or above. In a similar manner, an organization using a different rating scale may set a minimum score in a number of different manners.

An exemplary embodiment of the present invention additionally or alternatively involves the rating of each case in 37 different areas. These 37 areas are grouped according to the following outline:

I. Financial Planning

A. Financial Position

B. Protection Planning

1) Disability

2) Life Insurance

3) Long-Term Care

C. Investment Planning

D. Tax Planning

E. Retirement Planning

F. Estate Planning

II. Communication

III. Overall

More particularly, the 37 different areas being used may be configured as follows:

Financial Planning

Financial Position

1. Cash reserves

2. Budget/Expenses/Cash Flow/Debt Management

3. Overall Financial Position rating

Protection Planning

Disability Insurance

4. Affordability of Disability Insurance Recommendation

5. Feasibility of Goal Achievement regarding Disability Insurance recommendation

6. Overall rating of Disability Insurance section

Life Insurance

7. Affordability of Life Insurance Recommendation

8. Feasibility of Goal Achievement regarding Life Insurance recommendation

9. Overall rating of Life Insurance section

Long-Term Care

10. Affordability of Long-Term Care Recommendation

11. Feasibility of Goal Achievement regarding Long-Term Care Recommendation

12. Overall rating of Long-term Care section

Investment Planning

13. Affordability of Investment Planning Recommendation

14. Documentation of risk tolerance of the client

15. Exploration of tax ramifications of Investment Planning recommendation

16. Feasibility of Goal Achievement regarding investment planning recommendation

17. Overall rating of Investment Planning section

Tax Planning

18. Advice with respect to Tax-qualified investments

19. Advice with respect to Tax-deferred investments

20. Advice with respect to Tax-exempt investment

21. Advice regarding tax effect of liquidating certain investments

22. Advice regarding the hiring of a tax advisor

23. Overall rating of Tax Planning section

Retirement Planning

24. Affordability of Retirement Planning Recommendation

25. Documentation of risk tolerance regarding Retirement Planning

26. Exploration of tax ramifications of Retirement Planning Recommendation

27. Feasibility of Goal Achievement regarding Retirement Planning Recommendation

28. Overall rating of Retirement Planning section

Estate Planning

29. Advice regarding wills, trusts, or other estate planning techniques

30. Advice regarding beneficiary designations and/or ownership issues

31. Advice regarding Estate Tax situation

32. Advice regarding the hiring of an estate planning attorney

33. Overall rating of Estate Planning section

Communication

34. Linkage of various financial planning areas to another

35. Organization and presentation

36. Statement of sources of information and/or assumptions

Overall

37. Overall rating of the work-product

The overall rating may not be an average of the other ratings, but may instead be the assessor's overall feel for the quality of the product, in view of the client's needs. For example, if a client specifically requests Protection Planning advice, an assessor may take that fact into consideration by, for example, basing the overall score on the quality of the Protection Planning advice and giving less weight to the rating for the Estate Planning advice.

In the alternative, if a particular case is tailored such that no Estate Planning advice was asked for and none was given, no rating is needed for that category and the lack of Estate Planning advice has no effect on the rating in the Overall category. Thus, a case is not penalized merely because no mention is made, for example, of Estate Plannning advice. However, if a client specifically asks for Estate Planning advice and none is given, that fact should be reflected in the evaluation: preferably, a record is made of what advice a particular client is requesting. Ideally, the case reflects the areas of interest of the client by providing, in an overview or executive summary section, a description of why the client is seeking advice. It should be understood that the above listing of categories is merely exemplary and different categories may also be used. In addition, it should be understood that any number of categories can be used.

The evaluation process from an organization point of view may be configured in a number of different manners. In one embodiment of the present invention that may be used by a group of financial advisors, each advisor may have two of their cases selected for review. Such a selection of cases may be random, or it may be chronological (e.g., the most recently prepared case of the advisor may be selected), or it may be selected in another manner. In the alternative, instead of having all of the advisors in a group being evaluated, a portion of the group may be evaluated. This may occur if the organization uses a periodic cycle of reviews such that a portion of advisors are reviewed during each cycle and the cycle occurs, for example, twice a year. In that case, those who were reviewed in one cycle of reviews will be less likely to be reviewed in the next cycle of reviews.

All of the cases that were selected for evaluation are then presented to a group of assessors. The cases may be randomly assigned to the assessors. In the alternative, the cases may be assigned to the assessors in a predetermined manner, such as by specialty of the assessors, alphabetically, or several other manners known in the art. In either case, the two cases of one advisor may or may not be reviewed by the same assessor. The random assignment of assessors to advisors may aid in the impartial review of the cases. However, it should be noted that, in an exemplary embodiment, the advisor's identity is unknown to the assessor until the completion of the rating procedure. In that manner, concerns as to the impartiality of the assessors should be minimized.

Each case being rated may be independently evaluated by any number of assessors. In an exemplary embodiment, two assessors evaluate each case of the advisors being reviewed. The two cases may or may not have been written by the same advisor. In addition, a group of two assessors may or may not review the same set of cases. In the event that the two assessors reviewing a particular case disagree with respect to the overall rating to be given to the case, the case may be reviewed by a third assessor or arbitrator. In that event, the final evaluation of the case may be decided by the third assessor or arbitrator.

The arbitrator may review the case using the same criteria used by the other two assessors. In the event that the arbitrator's overall rating matches the rating of one of the assessors, the final overall rating of the case is determined to be the that of the assessor. In the, hopefully unlikely, event that the arbitrator's overall rating of the case does not match the rating of either assessor, several events may occur. In one embodiment, the case is further evaluated by additional arbitrators, until two scores match. In the alternative, the case may be assigned the overall rating assigned by the arbitrator. The arbitrator may or may not know the results of the ratings given by the previous assessors.

One advantage of using two or more assessors is that an assessor's bias is less likely to affect the results of the evaluation process if two assessors review a case. In the event that a biased assessor were to give undeservedly low (or high) ratings, the use of another assessor and arbitrator will likely prevent any such bias from affecting the process as a whole.

Once the evaluation of an advisor's cases is finished, the results of the evaluation are compiled. The scores in the various categories may be averaged throughout the entire group, thereby presenting an overview of any aspects of the group that need to be improved. In addition, the individual advisors whose cases have been reviewed are given the results of the reviews. If any of an advisor's reviewed cases received a rating that is below 3 in any category, that fact is pointed out to the advisor. By analyzing the shortcomings of an advisor, it is hoped that the advisor will improve his performance in the categories in which he is deficient.

As illustrated above, this invention provides detailed guidance to the assessors such that the financial advisors throughout the organization are rated on the same scale. In addition, this invention gives to the financial advisors an improved indication of what is expected of them when providing a written financial analysis. An advisor, by reviewing the scale on which they are rated, can easily determine what he should be including in his cases.

Furthermore, this invention allows a single organization, no matter how large, to present a uniform Level of advice to the clients by establishing a baseline standard. For example, an organization may mandate all cases to be rated 4 or above. Another organization, using the same scale, may require all cases to be at least Level 3 advice.

The present invention has been described above with reference to preferred embodiments. However, those skilled in the art will recognize that changes and modifications may be made to an exemplary embodiments without departing from the scope of the present invention. For example, cases may be rated on a different scale: the cases may be rated by assigning an alphabetic rating, instead of a numeric rating. The numeric rating may have a different range, such as from 1 to 10. The rating may be in descending order, with a rating of Level 1 indicating a high rating, as opposed to indicating a low rating. Each case may be reviewed by only one assessor. In the alternative, each case may be reviewed by three or more assessors. Each advisor may have any number of cases being reviewed by various assessors, varying from one case being reviewed to all cases prepared by the advisor being reviewed. The assessors may also be financial advisors, such that the advisors are providing peer review of cases. Indeed, one possible advantage of having other advisors perform the functions of the assessors is that the advisors may become more aware of what is expected of them by reviewing cases prepared by their peers.

In addition, while the invention has been described with respect to financial advice, the present invention may also be used to evaluate the work-product of people in other fields. Furthermore, while the present invention has been described as involving steps undertaken by humans, it is possible that the evaluation process may be computerized. As will be appreciated by one of ordinary skill in the art, the present invention may be embodied as a method, a data processing system, and/or a computer program product. Accordingly, the present invention may take the form of an entirely software embodiment, an entirely hardware embodiment, an embodiment combining aspects of both software and hardware, or an embodiment utilizing no computerization at all. Moreover, the present invention may be described herein in terms of functional block components, screen shots, optional selections and various processing steps. It should be appreciated that such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices.

Similarly, the software elements of the present invention may be implemented with any programming or scripting language with the various algorithms being implemented with any combination of data structures, objects, processes, routines or other programming elements. The present invention is described below with reference to block diagrams and flowchart illustrations of methods, apparatus (e.g., systems), and computer program products according to various aspects of the invention. It will be understood that each functional block of the block diagrams and the flowchart illustrations, and combinations of functional blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks. Further, it should be noted that the present invention may employ any number of conventional techniques for data transmission, signaling, data processing, network control, and the like. It will be appreciated, that many applications of the present invention could be formulated. One skilled in the art will appreciate that the network may include any system for exchanging data or transacting business, such as the Internet, an intranet, an extranet, WAN, LAN, satellite communications, and/or the like. The users may interact with the system via any input device such as a keyboard, mouse, kiosk, personal digital assistant, handheld computer (e.g., Palm Pilot®), cellular phone and/or the like.

These and other changes or modifications are intended to be included within the scope of the present invention, as expressed in the following claims.

We claim:

1. A method for evaluating the performance of a financial advisor comprising:
reading a case prepared by the financial advisor, wherein said case provides recommendations;
rating said case in a plurality of areas by comparing said case to a predetermined standard; and
assigning a numerical value for said case in each of said plurality of areas based on said rating.

2. The method of claim 1 further comprising repeating said reading, rating, and assigning steps for a plurality of cases for the financial advisor being evaluated.

3. The method of claim 2, wherein said repeating step is performed by a different person than said reading, comparing, and rating steps.

4. The method of claim 1 wherein said financial advisor is a member of a larger group of financial advisors, each group comprising a plurality of financial advisors, further comprising:
compiling data regarding the ratings of the group.

5. The method of claim 1 wherein a higher numerical value indicates increased compliance with said predetermined standard.

6. The method of claim 1 wherein said plurality of areas comprises: Financial Planning; Financial Position; Protection Planning; Disability; Life Insurance; Long-Term Care; Investment Planning; Tax Planning; Retirement Planning; Estate Planning; Communication; Overall rating.

7. The method of claim 1 wherein said plurality of areas comprises: Cash reserves; Budget/Expenses/Cash Flow/Debt Management; Overall Financial Position rating; Disability Insurance; Affordability of Disability Insurance Recommendation; Feasibility of Goal Achievement regarding Disability Insurance recommendation; Overall rating of Disability Insurance section; Affordability of Life Insurance Recommendation; Feasibility of Goal Achievement regarding Life Insurance recommendation; Overall rating of Life Insurance section; Affordability of Long-Term Care Recommendation; Feasibility of Goal Achievement regarding Long-Term Care Recommendation; Overall rating of Long-term Care section; Affordability of Investment Planning Recommendation; Documentation of risk tolerance of the client; Exploration of tax ramifications of Investment Planning recommendation; Feasibility of Goal Achievement regarding investment planning recommendation; Overall rating of Investment Planning section; Advice with respect to Tax-qualified investments; Advice with respect to Tax-deferred investments; Advice with respect to Tax-exempt investment; Advice regarding tax effect of liquidating certain investments; Advice regarding the hiring of a tax advisor; Overall rating of Tax Planning section; Affordability of Retirement Planning Recommendation; Documentation of risk tolerance regarding Retirement Planning; Exploration of tax ramifications of Retirement Planning Recommendation; Feasibility of Goal Achievement regarding Retirement Planning Recommendation; Overall rating of Retirement Planning section; Advice regarding wills, trusts, or other estate planning techniques; Advice regarding beneficiary designations and/or ownership issues; Advice regarding Estate Tax situation; Advice regarding the hiring of an estate planning attorney; Overall rating of Estate Planning section; Linkage of various financial planning areas to another; Organization and presentation; Statement of sources of information and/or assumptions; and Overall rating of the work-product.

8. The method of claim 1 wherein said reading, rating, and assigning steps are completed by a plurality of people.

9. The method of claim 1 wherein said reading, rating, and assigning steps are completed by a plurality of financial advisors.

10. The method of claim 1 wherein said reading, rating, and assigning steps are completed for each case in a subset of all cases produced by the financial advisor during a predetermined time period.

11. The method of claim 1 wherein said numerical value comprises a numerical rating that is an integer selected from the group consisting of 1, 2, 3, 4, and 5; and wherein:
a numerical rating of 1 in a particular category indicates that the advice in that category is considered questionable;
a numerical rating of 2 in a particular category indicates that the advice in that category is considered limited;
a numerical rating of 3 in a particular category indicates that the advice in that category is reasonably informative with respect to any actions that are recommended;
a numerical rating of 4 in a particular category indicates that the advice in that category details the reasons for the recommendation of a particular action and the manner in which an action should be performed; and
a numerical rating of 5 in a particular category indicates that the advice in that category sufficiently provides an analysis of alternative courses of actions in addition to detailing the reasons for the recommendation of a particular action.

12. The method of claim 11 further comprising:
providing negative feedback to said financial advisor if said numerical rating in a any of said plurality of categories is at least one of 1 and 2.

13. A method for evaluating the performance of a financial advisor comprising:
selecting a case prepared by the financial advisor, wherein said case provides recommendations;
selecting a first assessor and a second assessor;
rating said case in a plurality of areas by comparing said case to a predetermined standard;
assigning a first numerical value for said case in each of said plurality of areas based on said rating by said first assessor;
assigning a second numerical value for said case in each of said plurality of areas based on said rating by said second assessor; and
comparing said first numerical value to said second numerical value in one of said plurality of areas.

14. The method of claim 13 wherein said first numerical value is not equal to said second numerical value, said method further comprising:
selecting an arbitrator;
rating said case in a plurality of areas by comparing said case to a predetermined standard;
assigning a third numerical value for said case in each of said plurality of areas based on said rating by said arbitrator; and
finalizing said rating based on said third numerical value.

15. An evaluation system used to measure written work-product comprising:
a plurality of categories in which the work-product is to be rated; and
a rating scale with which to evaluate said work-product.

16. The evaluation system of claim 15 wherein said rating scale consists of integers ranging from 1 to 5.

17. The evaluation system of claim 15 in which said plurality of categories comprises:
Cash reserves; Budget/Expenses/Cash Flow/Debt Management; Overall Financial Position rating; Disability Insurance; Affordability of Disability Insurance Recommendation; Feasibility of Goal Achievement regarding Disability Insurance recommendation; Overall rating of Disability Insurance section; Affordability of Life Insurance Recommendation; Feasibility of Goal Achievement regarding Life Insurance recommendation; Overall rating of Life Insurance section; Affordability of Long-Term Care Recommendation; Feasibility of Goal Achievement regarding Long-Term Care Recommendation; Overall rating of Long-term Care section; Affordability of Investment Planning Recommendation; Documentation of risk tolerance of the client; Exploration of tax ramifications of Investment Planning recommendation; Feasibility of Goal Achievement regarding investment planning recommendation; Overall rating of Investment Planning section; Advice with respect to Tax-qualified investments; Advice with respect to Tax-deferred investments; Advice with respect to Tax-exempt investment; Advice regarding tax effect of liquidating certain investments; Advice regarding the hiring of a tax advisor; Overall rating of Tax Planning section; Affordability of Retirement Planning Recommendation; Documentation of risk tolerance regarding Retirement Planning; Exploration of tax ramifications of Retirement Planning Recommendation; Feasibility of Goal Achievement regarding Retirement Planning Recommendation; Overall rating of Retirement Planning section; Advice regarding wills, trusts, or other estate planning techniques; Advice regarding beneficiary designations and/or ownership issues; Advice regarding Estate Tax situation; Advice regarding the hiring of an estate planning attorney; Overall rating of Estate Planning section; Linkage of various financial planning areas to another; Organization and presentation; Statement of sources of information and/or assumptions; Overall rating of the work-product.
